(19) United States
(12) Patent Application Publication
(10) Pub. No.: US 2014/0004809 A1
(43) Pub. Date: Jan. 2, 2014

(54) FREQUENCY MIXER

(71) Applicant: ELECTRONICS AND TELECOMMUNICATIONS RESEARCH INSTITUTE, Daejeon (KR)

(72) Inventors: Jin Cheol JEONG, Daejeon (KR); Dong Pil CHANG, Daejeon (KR); In Bok YOM, Daejeon (KR)

(73) Assignee: Electronics and Telecommunications Research Institute, Daejeon (KR)

(21) Appl. No.: 13/792,941

(22) Filed: Mar. 11, 2013

(30) Foreign Application Priority Data
Jul. 2, 2012 (KR) 10-2012-0071849

(51) Int. Cl. H04B 1/04

(52) U.S. Cl. CPC H04B 1/0475
USPC 455/114.2

(57) ABSTRACT

Provided is a frequency mixer including: an oscillator configured to output an LO signal; a first converter configured to convert an input IF signal into different first and second IF signals; a first mixer configured to output a first RF signal in which the first IF signal is mixed with the LO signal and a first leakage signal; a second mixer configured to output a second RF signal in which the second IF signal is mixed with the LO signal and a second leakage signal; and a second converter configured to mix and attenuate the first and second leakage signals and output an RF signal in which the first and second RF signals are mixed, in order to minimize leakage power of an LO signal generated in a local oscillator in a transmitter for a communication system using a high frequency of 70 GHz or higher, such as an E-band.

### CROSS-REFERENCE TO RELATED APPLICATIONS

This application claims priority to and the benefit of Korean Patent Application No. 10-2012-0071849 filed in the Korean Intellectual Property Office on Jul. 2, 2012, the entire contents of which are incorporated herein by reference.

### TECHNICAL FIELD

The present invention relates to a frequency mixer, and more particularly, to a frequency mixer capable of minimizing leakage power of an LO signal generated in a local oscillator in a transmitter for a communication system using a high frequency of 70 GHz or higher, such as an E-band.

### BACKGROUND ART

In general, a band of 70 GHz or higher, which is known as an E-band, has attracted much attention worldwide as a next generation point-to-point (P2P) and a wireless backhaul link. E-band communication is known as a band capable of achieving transmission rates of several Gb/s while having a wide bandwidth due to a high carrier frequency. In a communication system using the high frequency, a leakage power characteristic of an oscillating frequency among characteristics of a transmitter is a very significant parameter. The reason is that, because output signal power of a power amplifier operated in the high frequency is relatively at a low level of power, LO leakage power at a certain level or higher generated from an output of a mixer saturates the power amplifier, such that a characteristic of a transmitter may be seriously degraded.

As described above, a transmitter of a high frequency is difficult to use a general type of a mixer and uses a sub-harmonic type mixer instead. When a general mixer is used, an LO signal of the E-band demanding power of 10 dBm or higher is required, and it is not easy to make the LO signal. Since the sub-harmonic type mixer may use a half of a frequency of an LO signal, it is possible to relatively easily realize a transmitter by using an LO signal of a frequency band between 30 to 50 GHz. The sub-harmonic type mixer may minimize LO leakage power, because uses the half of the frequency of the LO signal and thus may minimize LO leakage power represented at a double frequency of the frequency of an input LO signal.

As mentioned above, because an output level of a power amplifier is relatively low in the transmitter of a high frequency, leakage power of an LO frequency decreased due to the use of the sub-harmonic type mixer may be insufficient.

### SUMMARY OF THE INVENTION

The present invention has been made in an effort to provide a frequency mixer capable of minimizing LO leakage power generated in a transmitter for a communication system using a high frequency of 70 GHz or higher, such as an E-band.

An exemplary embodiment of the present invention provides a frequency mixer including: an oscillator configured to output an LO signal; a first converter configured to convert an input IF signal into different first and second IF signals; a first mixer configured to output a first RF signal in which the first IF signal is mixed with the LO signal and a first leakage signal; a second mixer configured to output a second RF signal in which the second IF signal is mixed with the LO signal and a second leakage signal; and a second converter configured to mix and attenuate the first and second leakage signals and output an RF signal in which the first and second RF signals are mixed.

The frequency mixer according to the exemplary embodiment may remove LO leakage power by using two sub-harmonic type mixers.

The frequency mixer according to the exemplary embodiment may use two sub-harmonic type mixers to have a simple structure and implement an MMIC.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a control block diagram illustrating a frequency mixer according to an exemplary embodiment.

FIG. 2 is a circuit diagram schematically illustrating the frequency mixer illustrated in FIG. 1.

FIG. 3 is a waveform diagram illustrating an output spectrum of the frequency mixer illustrated in FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

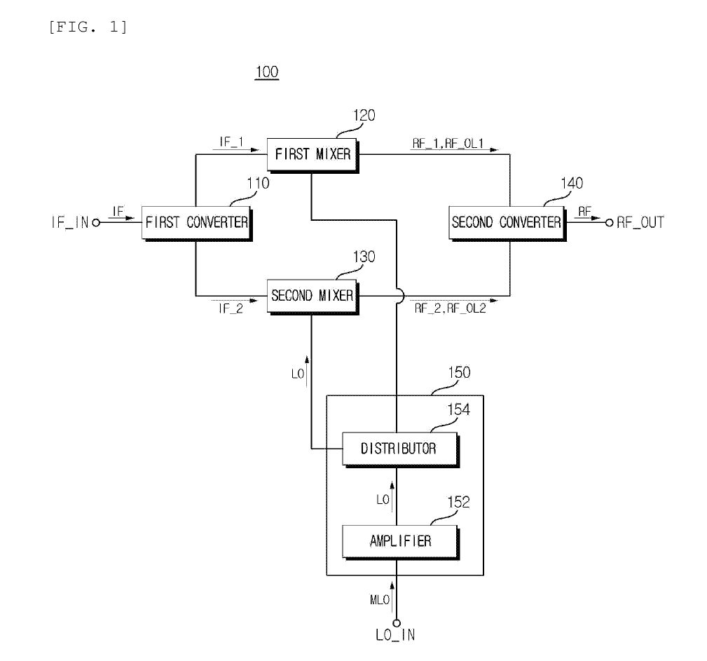

Hereinafter, a frequency mixer according to an exemplary embodiment will be described in detail based on parts necessary for understanding an operation and an effect with reference to accompanying FIGS. 1 to 3.

In describing constituent elements of an exemplary embodiment, different reference numbers may refer to like elements depending on the drawing, and like reference numerals may refer to like elements even though like elements are shown in different drawings. However, even in this case, it is not meant that a corresponding constituent element has a different function depending on an exemplary embodiment or has the same function in different exemplary embodiments, and a function of each constituent element may be determined based on a description of each constituent element in a corresponding exemplary embodiment.

In the following description of the exemplary embodiment, a detailed description of known functions and configurations incorporated herein will be omitted to avoid making the subject matter of the present invention unclear.

In describing the constructional elements of the exemplary embodiment, the terms of a first, a second, A, B, (a), (b), or the like, may be used. Such a term is only for discriminating the constituent element from another constituent element, and does not limit the essential feature, order, or sequence of the constituent element, or the like. If one constituent element is “coupled to”, “assembled with”, or “connected to” another constituent element, the one constituent element is directly coupled to or connected to another constituent element, but it can be understood as another different constituent element can be “coupled”, “assembled”, or “connected” between constituent elements.

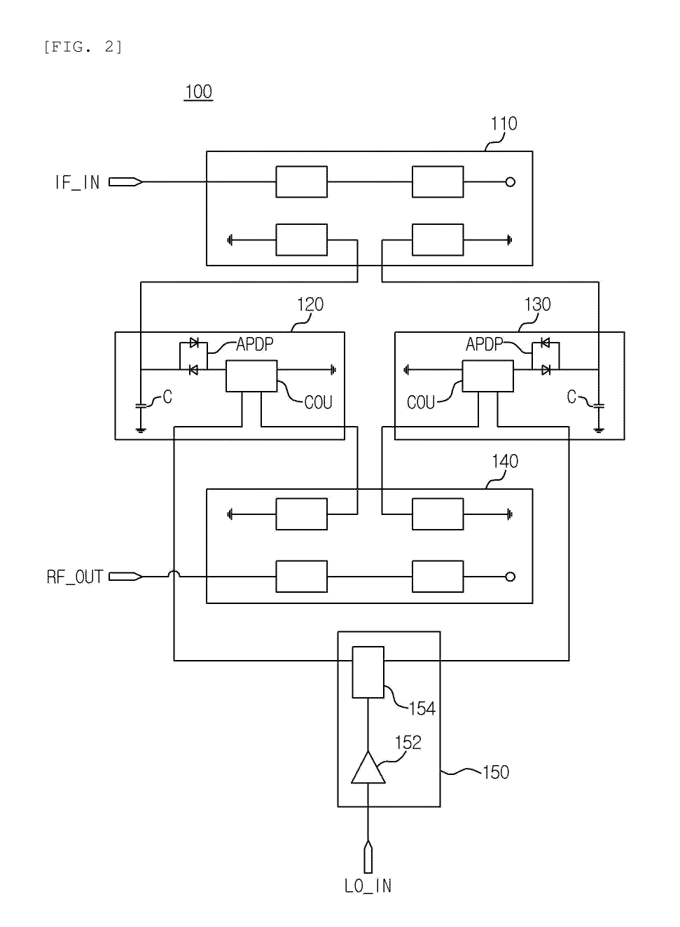

FIG. 1 is a control block diagram illustrating a frequency mixer according to an exemplary embodiment, and FIG. 2 is a circuit diagram schematically illustrating the frequency mixer illustrated in FIG. 1.

Referring to FIGS. 1 and 2, a frequency mixer 100 may include a first converter 110, first and second mixers 120 and 130, a second converter 140, and an oscillator 150.

Prior to describing the exemplary embodiment, it is described that a frequency is the same concept as a signal.

The first converter 110 may convert an intermediate frequency IF input from a first input terminal IF_IN into different first and second intermediate frequencies IF_1 and IF_2 and output the converted first and second intermediate frequencies IF_1 and IF_2.

Here, the first converter 110 may convert the input intermediate frequency IF into the first intermediate frequency IF_1 having a first phase and the second intermediate frequency IF_2 having a second phase that is different from the first phase and output the converted the first and second intermediate frequencies IF_1 and IF-2, and the first phase may have a phase difference of 180 degrees with respect to the second phase.

The first converter 110 may representatively be a balun device mainly used in designing a balanced mixer, a multiplier, and a push-pull amplifier.

Here, the balun device may be implemented by using a Lange coupler, a rat race coupler, and a directional coupler.

In the exemplary embodiment, it is described that the balun device is a Marchand balun device. The Marchand balun device may improve an RF characteristic by increasing a coupling coefficient between lines.

The Marchand balun device may increase the number of coupled lines in order to increase the coupling coefficient, and the coupled lines may be aligned in at least one direction of a horizontal direction and a vertical direction, and a detailed description thereof will be described with a description of the second converter 140.

Accordingly, the first converter 110 may divide the level of the intermediate frequency IF having a frequency band of 5 to 10 GHz input from the first input terminal IF_IN in half to divide the intermediate frequency IF as the first and second intermediate frequencies IF_1 and IF_2 having the first and second phases.

Prior to describing the first and second mixers 120 and 130, the oscillator 150 will be first described.

The oscillator 150 may include an amplifier 152 configured to amplify a reference oscillating frequency MLO input from a second input port LO_IN to the oscillating frequency LO, and a divider 154 configured to divide and supply the oscillating frequency LO amplified by the amplifier 152 to the first and second mixers 120 and 130.

Here, the reference oscillating frequency MLO generated by a local oscillator is input port LO_IN, and the reference oscillating frequency MLO is input in the amplifier 152.

The amplifier 152 may include at least one of an FET and a BJT, and it is described in the exemplary embodiment that the amplifier 152 is a power amplifier including the FET.

That is, the amplifier 152 may amplify power of the reference oscillating frequency MLO of low power compared to an output radio frequency RF to the oscillating frequency LO of high power.

In this case, the divider 154 may divide the oscillating frequency LO having the in-phase to the first and second mixers 120 and 130, and a Wilkinson-type divider may be applied thereto, but the divider 154 is not limited thereto.

The first mixer 120 may output a first radio frequency RF_1 and a first leakage frequency RF_LO1 by mixing the first intermediate frequency IF_1 input from the first converter 110 and the oscillating frequency LO input from the divider 154.

In this case, the first radio frequency RF_1 is a mixture of the oscillating frequency LO and the first intermediate frequency IF_1, and may have the first phase.

The second mixer 130 may output a second radio frequency RF_2 and a second leakage frequency RF_LO2 by mixing the second intermediate frequency IF_2 input from the first converter 110 and the oscillating frequency LO input from the divider 154.

The second radio frequency RF_2 is a mixture of the oscillating frequency LO and the second intermediate frequency IF_2, and may have the second phase.

Here, the first phase may have a phase difference of 180 degrees from the second phase.

The aforementioned first and second leakage frequencies RF_LO1 and RF_LO2 may be formed into leakage power leaked during a process of mixing the first and second intermediate frequencies IF_1 and IF_2 and the oscillating frequency LO in the first and second mixers 120 and 130, and the first and second leakage frequencies RF_LO1 and RF_LO2 have the in-phase.

In this case, the first and second mixers 120 and 130 may be a sub-harmonic type mixer, but are not limited thereto.

In the exemplary embodiment, it is described that the first and second mixers 120 and 130 are the sub-harmonic type mixers, but the first and second mixers 120 and 130 may be other-type mixers.

Here, the sub-harmonic type mixer may include an anti-parallel-diode pair (APDP), a Lange coupler (COU), and a capacitor (C), but is not limited thereto.

That is, the anti-parallel-diode pair (APDP) may be a single device in which two diodes are anti-parallel-coupled, but it is not limited thereto.

The Lange coupler (COU) may be connected to one side of the anti-parallel-diode pair (APDP), and the capacitor (C) may be connected to the opposite side of the anti-parallel-diode pair (APDP).

That is, the first and second mixers 120 and 130 may be formed in the same configuration.

The second converter 140 may convert the first and second radio frequencies RF_1 and RF_2 having the first and second phases input from the first and second mixers 120 and 130 into the radio frequencies having the same phase and output the coupled radio frequency RF to an output port RF_OUT.

In this case, the second converter 140 may be a balun device which has a different operational frequency from that of the first converter 110, but has the same type as that of the first converter 110, but is not limited thereto.

That is, the second converter 140 may couple the first and second radio frequencies RF_1 and RF_2 mixed in the first and second mixers 120 and 130 and the first and second leakage frequencies RF_LO1 and RF_LO2, and attenuate, cancel, or remove the first and second leakage frequencies RF_LO1 and RF_LO2 to output the radio frequency RF.

Also, the first and second radio frequencies RF_1 and RF_2 having the same size in opposite phase. And the first and seconde leakage frequencies RF_LO1 and RF_LO2 the same size in opposite phase. Here, the first and second leakage frequencies RF_LO1 and RF_LO2 corresponds to leakage power generated in another circuit within the first and second mixers 120 and 130 as described above, and a quality of the radio frequency RF may be improved by attenuating, cancelling, or removing leakage power.

The frequency mixer 100 according to the exemplary embodiment includes the first and second converters 110 and 140, the first and second mixers 120 and 130, and the oscillator 150, so that it is possible to remove leakage power with a simple structure and it may be easily implemented as an MMIC.

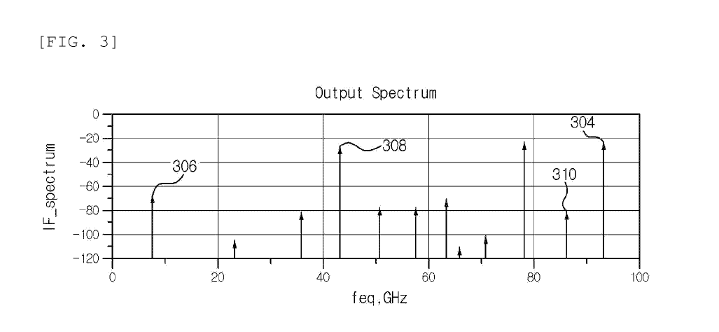

FIG. 3 is a waveform diagram illustrating an output spectrum of the frequency mixer illustrated in FIG. 1.

FIG. 3 may illustrate an output spectrum for the radio frequency RF output from the frequency mixer 100.

The output spectrum illustrated in FIG. 3 represents that the first and second leakage frequencies RF_LO1 and RF_LO2 to be attenuated, canceled, or removed by the second converter 140 are mixed and attenuated, and the first and second leakage frequencies RF_LO1 and RF_LO2 may be completely removed, but is not limited thereto.

As illustrated in FIG. 3, the output spectrum corresponds to the radio frequency RF desired by only a signal 304 at 93.5 GHz among spectrums of several frequencies, and the remaining spectrums correspond to frequencies to be attenuated, canceled, or removed.

Here, the first and second leakage frequencies RF_LO1 and RF_LO2 may approximately be a signal 308 at 43 GHz and a signal 310 at 86 GHz, respectively.

In this case, the signal 310 at 86 GHz is very close to the radio frequency RF, and thus may exert an influence to a characteristic of the transmitter.

The intermediate frequency IF is a signal 306 at 7.5 GHz and is long distant from the radio frequency RF, so that the intermediate frequency IF may not exert influence on a characteristic of the transmitter.

The frequency mixer 100 according to the exemplary embodiment includes the first and second mixers 120 and 130, and thus may remove the first and second leakage frequencies RF_LO1 and RF_LO2 constituting the signal 310 at 86 GHz of −80 dBm so as to have a difference of about 55 dBc from the radio frequency RF constituting the signal 304 at 93.5 GHz of −25 dBm.

Accordingly, the frequency mixer 100 according to the exemplary embodiment may improve spurious performance of the transmitter and has a simple structure, thereby implementing the MMIC.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A frequency mixer, comprising:
an oscillator configured to output an LO signal;
a first converter configured to convert an input IF signal into different first and second IF signals;
a first mixer configured to output a first RF signal in which the first IF signal is mixed with the LO signal and a first leakage signal;
a second mixer configured to output a second RF signal in which the second IF signal is mixed with the LO signal and a second leakage signal; and
a second converter configured to mix and attenuate the first and second leakage signals and output an RF signal in which the first and second RF signals are mixed.

2. The frequency mixer of claim 1, wherein the oscillator comprises:
an amplifier configured to amplify an input reference LO signal to the LO signal; and
a divider configured to divide the LO signal to the first and second converters.

3. The frequency mixer of claim 2, wherein the amplifier includes at least one of an FET and a BJT.

4. The frequency mixer of claim 1, wherein the first and second IF signals have a level corresponding to a half of a level of the IF signal.

5. The frequency mixer of claim 1, wherein the first IF signal has an opposite phase to that of the second IF signal.

6. The frequency mixer of claim 1, wherein the first and second mixers comprise:
an anti-parallel-diode-pair;
a Lange coupler connected to one side of the anti-parallel-diode-pair; and
a capacitor connected to an opposite side of the anti-parallel-diode-pair.

7. The frequency mixer of claim 1, wherein the first and second converters are a horizontal Marchand balun device.

8. The frequency mixer of claim 1, wherein the second converter outputs the RF signal by converting the first and second RF signals into signals having an in-phase and coupling the converted signals.
